(19) United States
(12) Patent Application Publication
(10) Pub. No.: US 2016/0244030 A1
(43) Pub. Date: Aug. 25, 2016

(54) ADJUSTABLE FOOT PAD FOR INTEGRATED VEHICLE JACK

(71) Applicant: Quadra Manufacturing, Inc., White Pigeon, MI (US)

(72) Inventors: Johnnie Eugene Lehman, Osceola, IN (US); Gary Anthony Lehman, Vicksburg, MI (US); Robert Daniel Slack, White Pigeon, MI (US)

(21) Appl. No.: 14/821,344

(22) Filed: Aug. 7, 2015

Related U.S. Application Data
(60) Provisional application No. 62/118,342, filed on Feb. 19, 2015.

(51) Int. Cl. B60S 9/12; B62D 63/08; B66F 3/38

(52) U.S. Cl. CPC B60S 9/12; B66F 3/38; B62D 63/08

(57) ABSTRACT

An example extendable jack foot includes a foot pad, an extension member, and a handle. The extension member and the handle are fixed to the foot pad. The extension member also defines a slot. The slot is configured to accept a connecting pin, slidably coupling the extendable jack foot to the distal end of a jack leg. The extendable jack foot can be moved with respect to the jack leg by a user, adjusting the position of the connecting pin within the slot. Positioning the connecting pin in various seat positions within the slot extends or retracts the effective length of the jack leg. No detachable parts are required.

### RELATED APPLICATIONS

This application claims the benefit of co-pending U.S. Provisional Patent Application Ser. No. 62/118,342 entitled “Adjustable Foot Pad For Integrated Vehicle Jack,” filed Feb. 19, 2015 by at least one common inventor, which is incorporated herein by reference in its entirety.

### BACKGROUND OF THE INVENTION

1. Field of the Invention

This invention relates generally to jacks, and more particularly to jacks that are fixed to vehicles. Even more particularly, this invention relates to a means of extending the length of jacks that are affixed to vehicles.

2. Description of the Background Art

Vehicles with integrated jacks are well known. For example, some recreational vehicles (RVs) have jacks affixed to the RV that are used for leveling and/or stabilizing the RV. As another example, semi-trailers typically include a pair of jacks that function to raise and lower the front end of the trailer to facilitate connecting and disconnecting the trailer from a towing truck.

The jacks of a vehicle must be capable of extending from a stowed position, where they are safe fur travel, to a fully deployed position that provides the required vehicle lift. In some vehicles, the extension length can be rather significant, because the trailer must be capable of connecting to trucks of different heights.

In systems with hydraulic jacks, the amount of extension required determines the length of the hydraulic cylinder used to extend the leg of the jack. In general, the cost of a hydraulic cylinder increases with the length of the cylinder. As a result, jacks with greater extension lengths require longer hydraulic cylinders and are, therefore, more expensive.

Telescoping jack legs provide a greater extension range, without increasing the length of the hydraulic cylinders. A typical telescoping jack leg includes two concentric cylinders. One of the cylinders includes a through hole for accepting a retaining pin. The other of the cylinders includes a plurality of through holes arranged along the length of the cylinder. The inner cylinder is withdrawn from or inserted into the outer cylinder until the jack leg is close to the desired length and a through hole of the outer cylinder is aligned with a through hole of the inner cylinder. The retaining pin is then inserted through the aligned through holes of the inner and outer cylinders to lock the inner cylinder and outer cylinder in place with respect to one another.

Although telescoping jack legs can provide an extended range of motion without the need for longer hydraulic drive cylinders, they still suffer from some disadvantages. For example, the retaining pins can be lost, rendering the jack leg incapable of supporting any weight. As another example, if an operator fails to replace the retaining pin, or the retaining pin becomes dislodged during transit, the jack leg can fall while the vehicle is in motion, causing serious damage to the jack leg. Telescoping jack legs are also susceptible to other types of damage. If one of the legs becomes even slightly bent, it can become difficult or impossible to slide the inner cylinder of the jack leg into and out of the outer cylinder. In addition, dirt and corrosion can interfere with the telescoping operation of telescoping jack legs, and one cylinder can become stuck in the other cylinder.

What is needed, therefore, is a vehicle jack with an increased range of extension that does not require longer drive cylinders. What is also needed is a vehicle jack with an increased range of extension that is not as susceptible to damage as currently known vehicle jacks. What is also needed is a vehicle jack with an increased range of extension that does not include detachable parts that can become lost or dislodged during transit.

### SUMMARY

The present invention overcomes the problems associated with the prior art by providing an extendable jack foot. The extendable jack foot increases the range of extension of the jack without requiring longer drive cylinders. With the extendable jack foot, the vehicle jack is less susceptible to damage than currently known vehicle jacks. The extendable jack foot provides an increased range of extension, but does not include detachable parts that can become lost or dislodged during transit.

An example extendable jack foot includes a foot pad and an extension member. The foot pad has a bottom surface and a top surface. The extension member is coupled to and extends from the top surface of the foot pad. The extension member also defines a slot, which is configured to receive a connecting pin. The slot defines a plurality of interconnected seat positions for receiving the connecting pin.

In a particular example embodiment, the extendable jack foot further includes the connecting pin for coupling the extendable jack foot to the distal end of a jack leg and a retainer coupled to prevent the connecting pin from sliding out of the slot. An example connecting pin includes a central portion, an end portion, and an engaging feature. The central portion is too large to pass through the slot, but the end portion is small enough to pass through the slot. The engaging feature is configured to engage the retainer.

In a more particular example embodiment, the slot is disposed on a first side of the extension member, and there is a complementary slot on a second side of the extension member.

In an even more particular example, the extension member includes a first plate and a second plate, and the second plate is spaced apart from the first plate. The first plate defines the slot and the second plate defines the complementary slot. The first plate also extends in a first upward direction and a first transverse direction. The second plate extends in a second upward direction and a second transverse direction. The first upward direction is parallel to the second upward direction, and the first transverse direction is parallel to the second transverse direction

In a more particular example embodiment, the interconnected seat positions include a plurality of transverse portions and an intermediate portion. The transverse portions are disposed to accept the connecting pin in a stable position. The intermediate portion facilitates the movement of the connecting pin between any two of the transverse portions. The transverse portions and the intermediate portion provide a means for adjusting the position of the extendable jack foot with respect to the connecting pin. More particularly, the transverse portions include an upper horizontal portion and a lower horizontal portion. Even more particularly the slot and the complementary slot are C-shaped. Alternatively the slot and the complementary slot can be E-shaped, or any other shape that facilitates the adjustment of the effective length of the jack leg.

In an even more particular example embodiment, the extendable jack foot also includes a handle. The handle can be fixed to the upper surface of the foot pad. The handle can also be disposed on the extension member. In alternate embodiments the handle can extend between the extension member and the foot pad, fixed to both. Even more particularly, the handle is formed from steel. Even more particularly, the handle includes a rubber cover to improve grip and comfort for a user.

A method of manufacturing an extendable jack foot is also disclosed. The method includes forming a foot pad, an extension member, and a slot within the extension member. The method further includes fixing the extension member to the foot pad, wherein the slot is configured to accept a connecting pin such that the extendable jack foot can be slidably coupled to the connecting pin. The method further includes providing a jack leg with a connecting pin and positioning the connecting pin through the slot. The method further includes attaching a retainer to the connecting pin to keep the connecting pin positioned within the slot.

A method of using an extendable jack foot is also disclosed. The method includes providing a jack leg with a connecting pin and coupling the extendable jack foot to the connecting pin. The method further includes adjusting the position of the extendable jack foot with respect to the connecting pin such that the effective length of the jack leg is extended when the jack leg is in a lifting configuration and the effective length of the jack leg is shortened when the jack leg is in a transit configuration.

Means for extendably coupling a foot pad to a jack leg are disclosed. For example, an extendable jack includes a jack leg, an actuator, a foot pad and a means for extendably coupling the foot pad to the jack leg. The jack leg has a first portion and a second portion movably coupled to the first portion. The actuator is coupled between the first portion of the jack leg and the second portion of the jack leg. The foot pad has a bottom surface and a top surface. In an example embodiment, the means for extendably coupling the foot pad to the second portion of the jack leg includes a rigid body with a bottom surface fixed to the top surface of the foot pad and a plurality of side surfaces. The rigid body also defines a slot extending from one side surface to an opposite side surface. The slot is configured to receive a connecting pin, such that by moving the rigid body with respect to the connecting pin, the effective length of the jack leg is extended or retracted.

### BRIEF DESCRIPTION OF THE DRAWINGS

The present invention is described with reference to the following drawings, wherein like reference numbers denote substantially similar elements:

FIG. 1 shows a perspective view of an extendable jack foot coupled to the distal end of a jack leg via a connecting pin;

FIG. 2 shows a hydraulic cylinder disposed inside the jack leg of FIG. 1;

FIG. 3 is a perspective view of the extendable jack foot of FIG. 1;

FIG. 4A is a side view of the extendable jack foot coupled to the jack leg in a travel position with no extension;

FIG. 4B is a side view of the extendable jack foot coupled to the jack leg in a lifting (load bearing) position with no extension;

FIG. 4C is a side view of the extendable jack foot coupled to the jack leg in a lower slide position;

FIG. 4D is a side view of the extendable jack foot coupled to the jack leg in an upper slide position;

FIG. 4E is a side view of the extendable jack foot coupled to the jack leg in a travel position with extension;

FIG. 4F is a side view of the extendable jack foot coupled to the jack leg in a lifting position with extension; and

FIG. 5 shows a perspective view of an alternate extendable jack foot.

### DETAILED DESCRIPTION

The present invention overcomes the problems associated with the prior art by providing an extendable jack foot that extends the effective length of a jack leg, does not include detachable parts, and/or is not as susceptible to damage as the prior art. The invention facilitates simple extension of a jack leg by moving the jack foot about a connecting pin disposed through a slot in the jack foot. In the following description, numerous specific details are set forth (e.g., shape of the slot, configuration of extension member, etc.) in order to provide a thorough understanding of the invention. Those skilled in the art will recognize, however, that the invention may be practiced apart from these specific details.

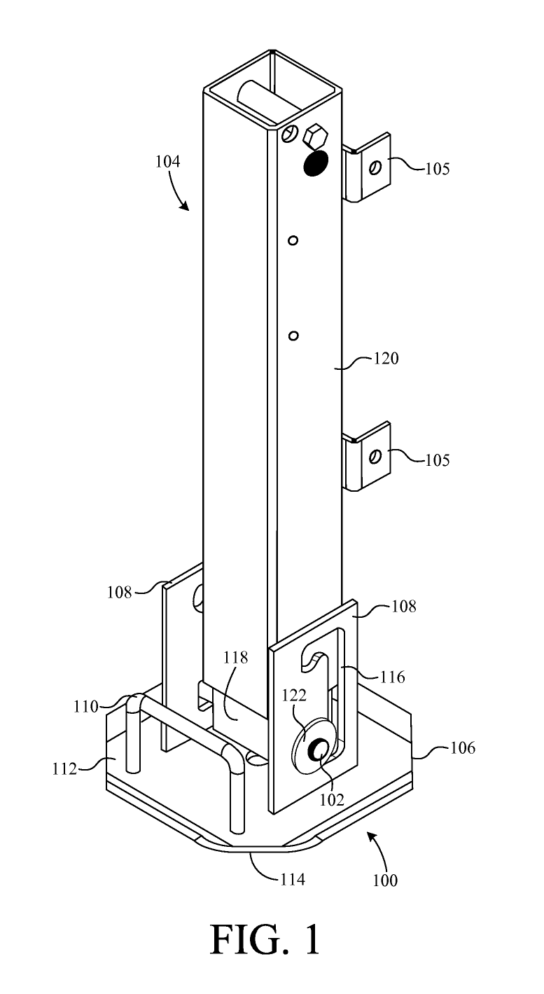

FIG. 1 shows an extendable jack foot 100, a connecting pin 102, and a jack leg 104. Extendable jack foot 100 is adjustably coupled to jack leg 104 by connecting pin 102. Extendable jack foot 100 extends the effective length of jack leg 104, which is coupled to a vehicle (not shown) by brackets 105.

Extendable jack foot 100 includes a foot pad 106, an extension member 108, and a handle 110. Foot pad 106 includes an upper surface 112 and a lower surface 114 Extension member 108 and handle 110 are fixed to upper surface 112 of foot pad 106. Extension member 108 defines a slot 116, configured to accept connecting pin 102, and couples jack foot 100 to jack leg 104 by accepting connecting pin 102 within slot 116 in a slidable engagement. Thus, slot 116 provides a means for adjusting the position of extendable jack foot 100 with respect to connecting pin 102. Foot pad 106 distributes the weight of a load supported by extendable jack foot 100 and jack leg 104 over a larger area of the ground, preventing the lower end of jack leg 104 from being driven into the ground. In alternate embodiments foot pad 106 can have any of a variety of different shapes and thicknesses adequate to disperse the intended load.

In this example embodiment, handle 110 is a cylindrical rod that is bent at 90-degree angles at two points along its length, creating a C-shaped rod. Each end of the rod is fixed (e.g., welded) to upper surface 112. Handle 110 is oriented parallel to an axis of connecting pin 102. In alternate embodiments, handle 110 can be fixed to extension member 108, or handle 110 can be oriented perpendicular to the axis of connecting pin 102. Handle 110 can optionally include a rubber grip or contour features to make it even easier to grasp and manipulate jack foot 100.

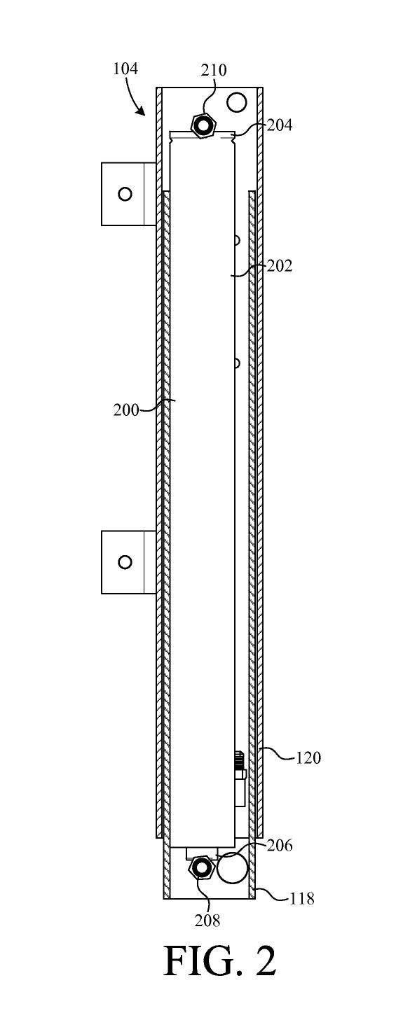

Jack leg 104 includes a lower jack leg 118 and an upper jack leg 120, slidably engaged with one another. Lower jack leg 118 and upper jack leg 120 extend or shorten the length of jack leg 104 by sliding into and out of one another, responsive to an actuator (e.g., hydraulic cylinder 200 of FIG. 2). In alternate embodiments lower jack leg 118 and upper jack leg 120 can be any of a variety of complementary shapes that allow extension or retraction of jack leg 104.

Connecting pin 102 includes retainers 122 (only 1 visible in FIG. 1), each fixed to a respective end of connecting pin 102. Retainers 122 maintain the engagement of connecting pin 102 and slot 116, but allow movement of extension member 108 with respect to connecting pin 102. Alternatively, connecting pin 102 can define channels configured to receive the edges of slot 116, preventing connecting pin 102 from sliding out of slot 116. As another alternative, the ends of connecting pin 102 can be threaded in order to receive a complementary threaded fastener, which will prevent connecting pin 102 from sliding out of slot 116. As yet another alternative, connecting pin 102 can be omitted and replaced by any similarly functioning protrusion from the surface of lower jack leg 118.

FIG. 2 shows a hydraulic cylinder 200 disposed within jack leg 104. Hydraulic cylinder 200 includes a cylinder barrel 202, which is fixed to a cylinder head 204, and a piston rod 206, which is disposed within cylinder barrel 202. Piston rod 206 is fixed, by a lower connecting pin 208, to lower jack leg 118, and cylinder head 204 is fixed, by an upper connecting pin 210, to upper jack leg 120. Hydraulic cylinder 200 is a double-acting cylinder that extends or retracts the length of jack leg 104. When hydraulic cylinder 200 is driven by a hydraulic pump (not shown), piston rod 206 extends from or retracts into cylinder barrel 202. When piston rod 206 extends from cylinder barrel 202, lower jack leg 118 slides out of upper jack leg 120, thus extending the length of jack leg 104. When piston rod 206 retracts into cylinder barrel 202, lower jack leg 118 slides into upper jack leg 120, thus shortening the length of jack leg 104.

In alternate embodiments hydraulic cylinder 200 can be replaced by any conceivable type of actuator, including, but not limited to, mechanical, pneumatic, and/or electric actuators.

Additionally, lower connecting pin 208 can also function as connecting pin 102, thereby reducing the number of required parts while retaining their function.

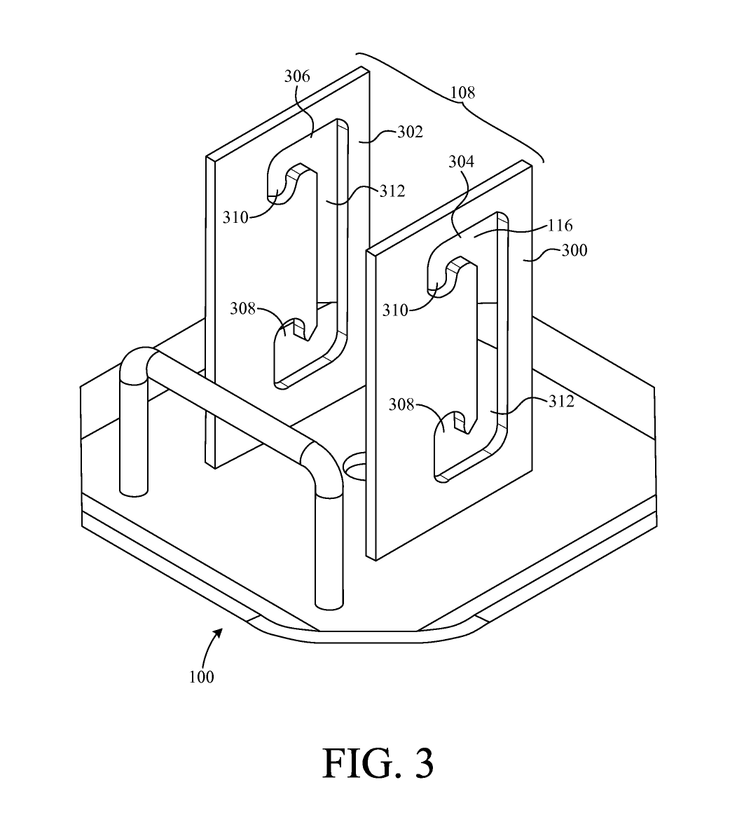

FIG. 3 shows extendable jack foot 100 removed from connecting pin 102 and jack leg 104 (FIG. 1). Extension member 108 includes a first plate 300 and a second plate 302, defining a first slot 304 and a complementary second slot 306, respectively. First slot 304 and second slot 306 are configured to each accept an opposite end of connecting pin 102 in a slidable engagement and to each include a lower transverse portion 308, an upper transverse portion 310, and an intermediate portion 312. In the example embodiment, lower transverse portion 308, upper transverse portion 310, and intermediate portion 312 combine to form a C-shaped slot. When connecting pin 102 is seated in lower transverse portion 308, extension member 108 does not extend the effective length of jack leg 104. However, when connecting pin 102 is seated in upper transverse portion 310, extension member 108 does extend the effective length of jack leg 104. Intermediate portion 312 facilitates the transition of connecting pin 102 between lower transverse portion 308 and upper transverse portion 310.

The slidable engagement between connecting pin 102 and slots 304 and 306 functions as a travel limiter for jack foot 100. In particular, a user can move jack foot 100 by pivoting extension member 108 about connecting pin 102 and/or sliding extension member 108 over connecting pin 102 in the forward, backward, upward, and/or downward directions. However, the translational motion of jack foot 100 is limited to a two-dimensional plane, and the travel of jack foot 100 within the two-dimensional plane is limited by the borders of slots 304 and 306. The closed character of slots 304 and 306 prevents extension member 108, and therefore jack foot 100, from disengaging pin 102 and lower jack leg 118 (FIG. 1).

In alternate embodiments, extension member 108 can be a unitary body (e.g., a sectioned, rectangular cylinder) defining one or more slots. In addition, slot 304 and complementary slot 306 can have any conceivable shape (e.g. E-shaped) that defines a plurality of seat positions and interconnecting passages between the seat positions.

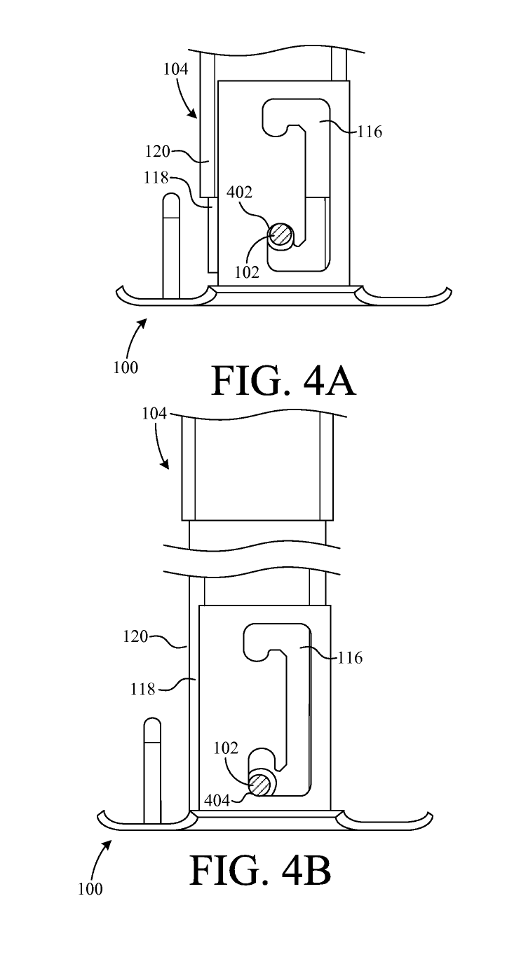

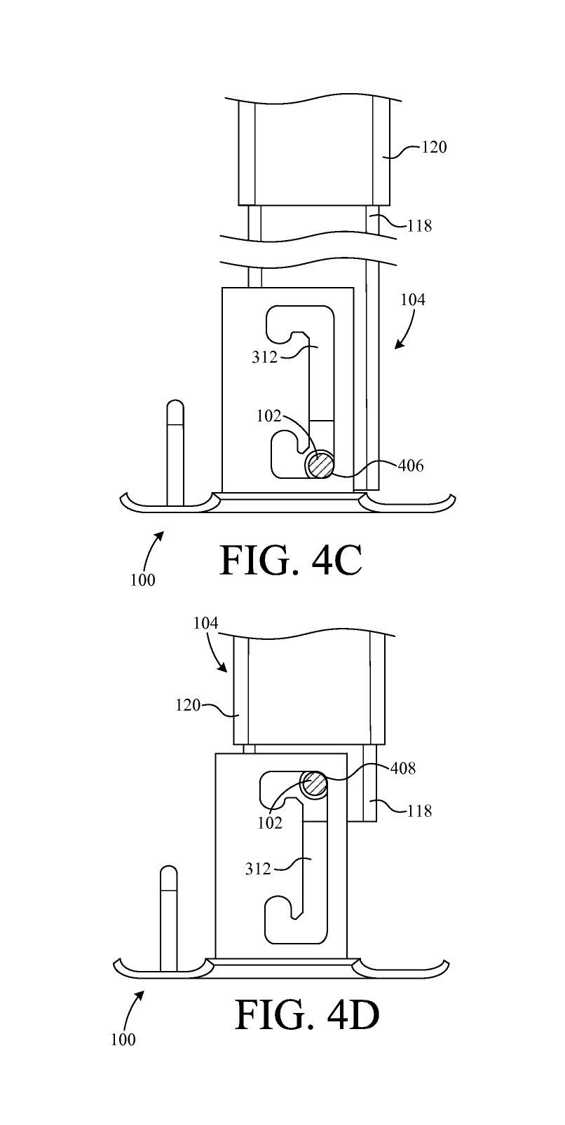

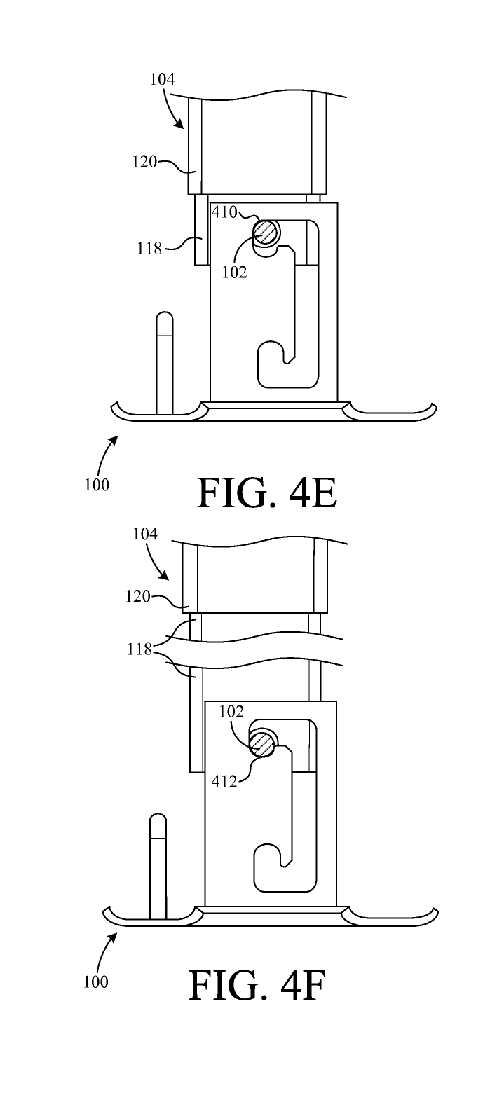

FIGS. 4A-E show extendable jack foot 100 in a variety of positions. Slot 116 defines a plurality of seat positions for connecting pin 102, including a lower hanging seat position 402 (FIG. 4A), a lower lifting (load bearing) seat position 404 (FIG. 4B), a lower intermediate seat position 406 (FIG. 4C), an upper intermediate seat position 408 (FIG. 4D), an upper hanging seat position 410 (FIG. 4E), and an upper lifting seat position 412 (FIG. 4F). A user can easily manipulate jack foot 100 to position connecting pin 102 in, or move connecting pin 102 between, any of seat positions 402, 404, 406, 408, 410, and 412.

FIG. 4A shows extendable jack foot 100 in anon-extended position with lower jack leg 118 retracted into upper jack leg 120 (e.g., stowed). Connecting pin 102 is seated within lower hanging seat position 402, such that extendable jack foot 100 hangs from connecting pin 102.

This position maximizes the distance between jack foot 100 and the ground and, therefore, is suitable for travel

FIG. 4B shows extendable jack foot 100 in a non-extended, load bearing position. Connecting pin 102 is seated in lower lifting seat position 404, such that extendable jack foot 100 is forced against the ground when jack leg 104 is being extended. In this configuration, extending jack leg 104 will lift and/or support the vehicle, trailer, or other object that is coupled to upper jack leg 120.

FIG. 4C shows extendable jack foot 100 in a non-extended, transition position. Connecting pin 102 is positioned in lower intermediate seat position 406. Although jackfoot 100 can bear a load in this position, intermediate position 406 also facilitates the transition of extendable jack foot 100 into an extended, travel position shown in FIG. 4D. For example, when there is no load on jack leg 104, retracting lower jack leg 118 will cause connecting pin 102 to travel upward through intermediate portion 312 of slot 116 toward upper intermediate seat position 408. Thereafter, further retraction of lower jack leg 118 will lift jack foot 100 off of the ground. In addition, when jack foot 100 is in the non-extended stowed position shown in FIG. 4A, a user can lift jack foot 100 slightly, move jack foot 100 forward (from right to left in the view of FIGS. 4A-F) to position connecting pin 102 in intermediate position 406, then lower jack foot into the extended position shown in FIG. 4D. Obviously, the reverse process will transition jack foot 100 from the extended position to the non-extended position.

FIG. 4D shows extendable jack foot 100 in an extended, transition position. Connecting pin 102 is positioned in upper intermediate position 408. Although jack foot 100 can hang suspended by connecting pin 102 in upper intermediate position 408, position 408 also facilitates the easy transition of connecting pin 102 into upper hanging seat position 410 by sliding jack foot 100 backward (from left to right in the view of FIGS. 4A-F).

FIG. 4E shows extendable jack foot 100 in an extended, travel position. Connecting pin 102 is seated within upper hanging seat position 410, such that extendable jack foot 100 will hang from connecting pin 102 when jack leg 104 is not bearing a load.

FIG. 4F shows extendable jack foot 100 in an extended, load bearing position. Connecting pin 102 is seated within upper lifting seat position 412, such that extendable jack foot 100 is forced against the ground when jack leg 104 is extended. In this configuration, extending jack leg 104 will lift and/or support the vehicle, trailer, or other object that is coupled to upper jack leg 120. In addition, in this position, the effective length of jack leg 104 is increased by extendable jack foot 100, thereby reducing the amount of extension required of hydraulic cylinder 200.

The various positions of jack foot 100 are clearly shown in the side views of FIGS. 4A-F. However, for the sake of completeness, it should be noted that when the visible end of connecting pin 102 occupies any position within first slot 304, the opposite end of connecting pin 102 will be positioned in corresponding position within complementary second slot 306.

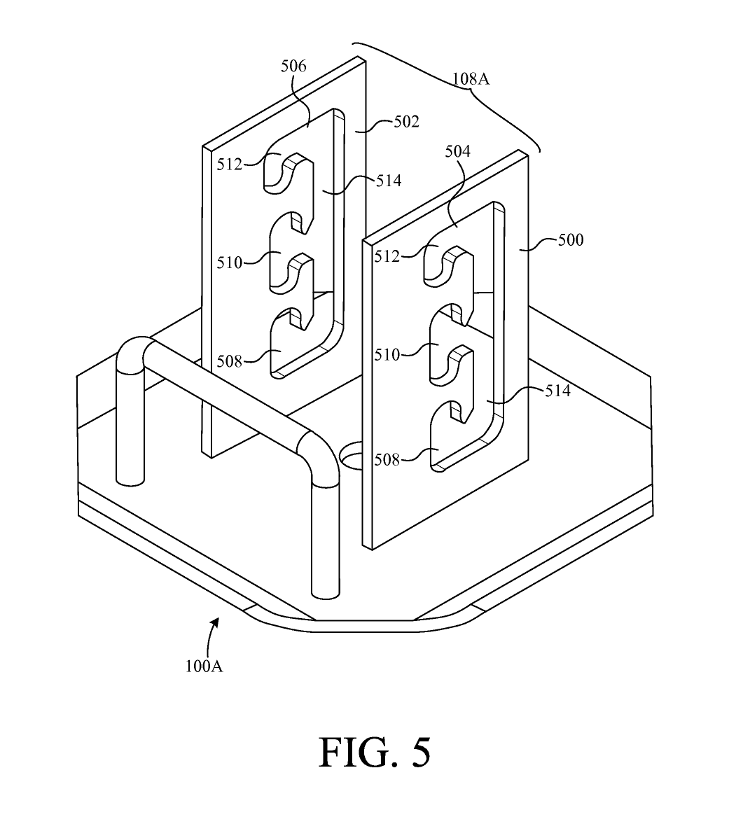

FIG. 5 is a perspective view of an alternate extendable jack foot 100A, shown without connecting pin 102 or jack leg 104. Alternate jack foot 100A is similar to jack foot 100, except that it includes an alternate extension member 108A that defines an increased number of seat positions and, therefore, provides greater flexibility with respect to the extension lengths available.

Alternate extension member 108A includes a first plate 500 and a second plate 502, configured to receive connecting pin 102 in a slidable engagement and defining a first slot 504 and a second slot 506, respectively. First slot 504 and second slot 506 each include a lower transverse portion 508, a middle transverse portion 510, an upper transverse portion 512, and an intermediate portion 514. In the example embodiment, lower transverse portion 508, middle transverse portion 510, upper transverse portion 512, and intermediate portion 514 combine to form an E-shaped slot. When connecting pin 102 is seated in lower transverse portion 508, the effective length of jack leg 104 is not extended by jack foot 100. When connecting pin 102 is seated in middle transverse portion 510, the effective length of jack leg 104 is extended by jack foot 100 by a first distance. When connecting pin 102 is seated in upper transverse portion 512, the effective length of jack leg 104 is extended by a second distance, greater than the first distance, by extendable jack foot 100. Intermediate portion 514, provides a means for transitioning connecting pin 102 between transverse portions 508, 510, and 512, thereby facilitating adjustment of jack foot 100 between the extended, partially extended, and a non-extended positions.

The description of particular embodiments of the present invention is now complete. Many of the described features may be substituted, altered or omitted without departing from the scope of the invention. For example, alternate jack types (e.g., electric jacks, mechanical jacks, etc.) may be substituted for the hydraulic jack shown. As another example, the slot may be any shape that facilitates easy adjustment of the jack foot as well as provides stable seat positions for hanging and lifting. These and other deviations from the particular embodiments shown will be apparent to those skilled in the art, particularly in view of the foregoing disclosure.

We claim:

1. An extendable jack foot comprising:
a foot pad having a bottom surface and a top surface;
an extension member coupled to and extending from said top surface of said foot pad, said extension member defining a slot configured to receive a connecting pin; and wherein
said slot defines a plurality of interconnected seat positions.

2. The extendable jack foot of claim 1, further comprising said connecting pin for coupling said extendable jack foot to the distal end of a jack leg.

3. The extendable jack foot of claim 2, further comprising a retainer coupled to prevent said connecting pin from sliding out of said slot.

4. The extendable jack foot of claim 3, wherein said connecting pin includes:
a central portion too large to pass through said slot;
an end portion small enough to pass through said slot; and
an engaging feature configured to engage said retainer.

5. The extendable jack foot of claim 1, wherein:
said slot is disposed on a first side of said extension member; and
said extension member further defines a complementary slot on a second side of said extension member.

6. The extendable jack foot of claim 5, wherein:
said extension member includes a first plate and a second plate, said second plate spaced apart from said first plate;
said first plate defines said slot; and
said second plate defines said complementary slot.

7. The extendable jack foot of claim 6, wherein:
said first plate extends in a first upward direction and a first transverse direction;
said second plate extends in a second upward direction and a second transverse direction;
said first upward direction is parallel to said second upward direction; and
said first transverse direction is parallel to said second transverse direction.

8. The extendable jack foot of claim 7, wherein:
said slot and said complementary slot are C-shaped; and
said extendable jack foot further comprises a handle fixed to said top surface of said foot pad at a location faced by an open side of said “C” shape and oriented in a direction that is perpendicular to both of said first transverse direction and said second transverse direction.

9. The extendable jack foot of claim 5, wherein said interconnected seat positions include:
a plurality of transverse portions disposed to accept said connecting pin in a stable position;
an intermediate portion to facilitate the movement of said connecting pin between any two of said transverse portions; and wherein
said transverse portions and said intermediate portion provide a means for adjusting the position of said extendable jack foot with respect to said connecting pin.

10. The extendable jack foot of claim 9, wherein said slot and said complimentary slot include chamfered edges.

11. The extendable jack foot of claim 10, wherein said transverse portions include an upper horizontal portion and a lower horizontal portion.

12. The extendable jack foot of claim 10, wherein said slot and said complementary slot are C-shaped.

13. The extendable jack foot of claim 10, wherein said slot and said complementary slot are E-shaped.

14. The extendable jack foot of claim 1, additionally comprising a handle disposed on said foot pad.

15. The extendable jack foot of claim 1, additionally comprising a handle disposed on said extension member.

16. A method of manufacturing an extendable jack foot, said method comprising:
forming a foot pad;
forming an extension member;
fixing said extension member to said foot pad; and
forming a slot within said extension member; and
wherein said slot is configured to accept a connecting pin such that said extendable jack foot can be slidably coupled to said connecting pin.

17. The method of claim 16:
providing a jack leg with a connecting pin;
positioning said connecting pin through said slot; and
attaching a retainer to said connecting pin within said slot.

18. A method of using an extendable jack foot, said method comprising:
providing a jack leg with a connecting pin;
coupling said extendable jack foot to said connecting pin; and
adjusting the position of said extendable jack foot with respect to the connecting pin such that the effective length of the jack leg is extended when said jack leg is in a lifting configuration and said effective length of said jack leg is shortened when said jack leg is in a transit configuration.

19. An extendable jack comprising:
a jack leg having a first portion and a second portion movably coupled to said first portion;
an actuator coupled between said first portion of said jack leg and said second portion of said jack leg;
a foot pad having a bottom surface and a top surface;
means for extendably coupling said foot pad to said second portion of said jack leg.
